(19) United States
(12) Patent Application Publication
(10) Pub. No.: US 2015/0264431 A1
(43) Pub. Date: Sep. 17, 2015

(54) PRESENTATION AND RECOMMENDATION OF MEDIA CONTENT BASED ON MEDIA CONTENT RESPONSES DETERMINED USING SENSOR DATA

(71) Applicant: Sylvia Hou-Yan Cheng, San Francisco, CA (US)

(72) Inventor: Sylvia Hou-Yan Cheng, San Francisco, CA (US)

(73) Assignee: AliphCom, San Francisco, CA (US)

(21) Appl. No.: 14/213,439

(22) Filed: Mar. 14, 2014

(51) Int. Cl. H04N 21/442; H04N 21/258; H04N 21/262; H04N 21/45; H04N 21/466; H04N 7/173; H04N 21/422

(52) U.S. Cl. CPC H04N 21/44218; H04N 7/173; H04N 21/25891; H04N 21/42201; H04N 21/4532; H04N 21/4667; H04N 21/26241; H04N 21/26283

(57) ABSTRACT

Techniques for presenting and recommending media content based on media content responses are described. Disclosed are techniques for receiving data associated with a portion of media content, receiving a set of sensor data from one or more sensors coupled to a wearable device, comparing the set of sensor data to one or more templates to determine a response to the portion of media content, and causing presentation of information associated with the response at a display. The portion of media content may be configured to be presented at the display. The set of sensor data may include galvanic skin response (GSR) data.

### FIELD

Various embodiments relate generally to electrical and electronic hardware, computer software, human-computing interfaces, wired and wireless network communications, telecommunications, data processing, wearable devices, and computing devices. More specifically, disclosed are techniques for presenting and recommending media content based on media content responses determined using sensor data.

### BACKGROUND

Ratings on media content, such as television contents, allow content providers to improve the media content provided and advertised to target audiences. Conventional ratings are generally based on the number of viewers. However, such ratings are of limited use as they generally do not reflect the level of interest of the viewers. Alternatively, conventional ratings may be provided on a forum, such as an Internet forum, on which users manually enter their ratings for media content. However, such ratings are generally inaccurate because they rely on users' after-the-fact manual input. Conventional ratings typically give providers and users a limited understanding of the popularity of media content.

Thus, what is needed is a solution for presenting and recommending media content without the limitations of conventional techniques.

### BRIEF DESCRIPTION OF THE DRAWINGS

Various embodiments or examples (“examples”) are disclosed in the following detailed description and the accompanying drawings:

FIG. 1 illustrates a media device with a media content response manager, according to some examples;

FIG. 2 illustrates an application architecture for a media content response manager, according to some examples;

FIG. 3 illustrates an application architecture for a recommendation and control facility to be used with a media content response manager, according to some examples;

FIG. 4 illustrates responses to a portion of media content over time, determined by a media content response manager, according to some examples;

FIG. 5 illustrates a recommendation generated by a recommendation and control facility to be used with a media content response manager, according to some examples;

FIG. 6 illustrates a network of wearable devices of a plurality of users, the wearable devices to be used with one or more media content response managers, according to some examples;

FIGS. 7A and 7B illustrate a process for a media content response manager, according to some examples; and

FIG. 8 illustrates a computer system suitable for use with a media content response manager, according to some examples.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

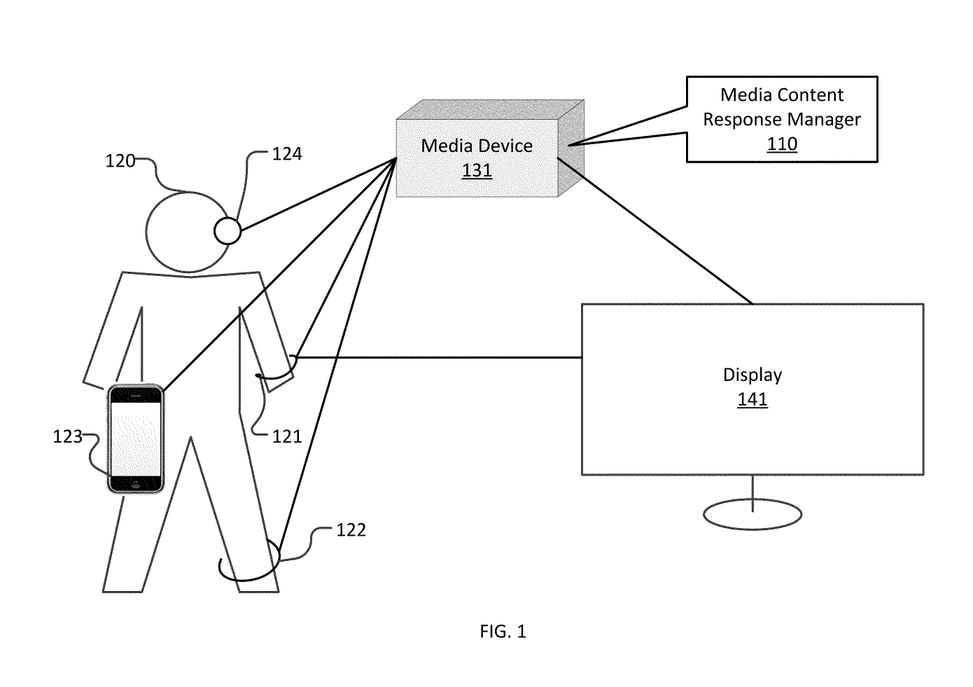

FIG. 1 illustrates a media device with a media content response manager, according to some examples. As shown, FIG. 1 includes a user 120, wearable devices 121-124, a media device 131, a display 141, and a media content response manager 110. Media content response manager 110 may be configured to determine a user's response, such as an emotional response, a physical response, and the like, to media content or a portion or piece of media content, such as a television program (e.g., broadcast, cable, etc.), a movie (e.g., via DVD, streaming (e.g., Netflix, Hulu, etc.), etc.), a song or other audio content, an advertisement or commercial, and the like. Media content response manager 110 may rank media content based on a user's response, or an aggregation of responses of a plurality of users. Media content response manager 110 may also store a user's response to media content in a user profile, and may share the user's response with other users. In some examples, media content response manager 110 may receive data associated with media content, such as data identifying the media content (e.g., identifier, unique number, code, name, etc.). The media content may be configured to be presented at display 141. Media content response manager 110 may also receive sensor data from one or more sensors coupled to wearable devices 121-124. Media content response manager 110 may compare the sensor data to one or more templates to determine a response of user 120 and/or a level of the response of user 120. For example, media content response manager 110 may determine that user 120 is happy, sad, frightened, and the like, while watching the media content at display 141. Media content response manager 110 may determine that user 120 is very happy, moderately happy, slightly happy, and the like. Media content response manager 110 may also determine a physical response of user 120, such as an activity that user 120 is engaged in while the media content is being presented (e.g., sitting, walking around, exercising, sleeping, etc.). Media content response manager 110 may determine a user's responses to a plurality of media content, and display information associated with the responses, such as, a ranking of the media content based on the responses.

In some examples, media content response manager 110 may generate recommendations to a user based on the effect that a response to media content has on a user's sleep, based on a user's programming tastes and preferences, based on a user's parental or other control systems, and the like. In some examples, media content response manager 110 may receive additional sensor data from wearable devices 121-124, and use the additional sensor data to determine a sleep quality of user 120, after media content has been presented at display 141. Sleep quality may be based on a duration of sleep (e.g., the length of time user 120 is asleep), a duration of deep sleep, a ratio of the lengths of time user 120 is in deep sleep to light sleep, and the like. For example, the response of user 120 to a portion of media content may be being very frightened. User 120 may need a long time to attain sleep onset (e.g., a transition from being awake to being asleep), which may reduce a duration of user 120's sleep. Media content response manager 110 may store data associated with the user's response (e.g., being very frightened) in the user's profile. Media content response manager 110 may generate a recommendation that user 120 not watch media content associated with being very frightened before user 120's bedtime. In some examples, media content response manager 110 may store a plurality of responses of user 120 to a plurality of media content in a user profile. The plurality of responses may indicate or correspond with the programming tastes or preferences of user 120 (e.g., the type of media content that user 120 enjoys, likes, watches most, etc.). Media content response manager 110 may use the user profile to recommend other media content that are associated with similar responses. In some examples, media content response manager 110 may receive data representing a user profile that includes a response that is associated with controlled media content, such as media content that user 120 is not authorized or not recommended to watch, listen to, or enjoy. For example, the user profile may include a parental control, and user 120 may be banned from watching media content associated with a response of being very frightened. Media content response manager 110 may receive data associated with a portion of media content, including a response associated with the portion of media content (e.g., one or more responses to the portion of media content of one or more other users). Media content response manager 110 may compare this response to the response indicating controlled media content stored in the user's profile. If there is a match (e.g., a similarity within a tolerance), then media content response manager 110 may not present the media content, or may present a recommendation stating that user 120 may not watch the media content.

Display 141 may be a device configured to present information in a visual or tactile form. Examples include cathode ray tube displays (CRT), liquid crystal displays (LCD), light-emitting diodes (LED), interferometric modulator display (IMOD), electrophoretic ink (E Ink), organic light-emitting diode (OLED), tactile electronic displays, and the like.

In some examples, display 141 may receive input signals from media device 131. Media device 131 may generate output based on input data signals, such as over-the-air or broadcast signals, satellite signals (e.g., satellite television), streaming signals (e.g., streaming over the Internet or a network), from a disc (e.g., DVD, VCD, gaming module, etc.), and the like. In other examples, display 141 may receive input signals from a cable television set-top box (not shown), which may generate output based on cable television input data signals. Either media device 131 or a set-top box may be implemented as a separate device from display 141, or may be integrated with, fabricated with, or located on display 141.

Wearable devices 121-124 may be may be worn on or around an arm, leg, ear, or other bodily appendage or feature, or may be portable in a user's hand, pocket, bag or other carrying case. As an example, a wearable device may be a data-capable band 121-122, a smartphone or mobile device 123, and a headset 124. Other wearable devices such as a watch, data-capable eyewear, cell phone, tablet, laptop or other computing device may be used.

Wearable devices 121-124 may be configured to capture or detect data using one or more sensors. A sensor may be internal to a wearable device (e.g., a sensor may be integrated with, manufactured with, physically coupled to the wearable device, or the like) or external to a wearable device (e.g., a sensor physically coupled to wearable device 121 may be external to wearable device 122, or the like). A sensor external to a wearable device may be in data communication with the wearable device, directly or indirectly, through wired or wireless connection. Various sensors may be used to capture various sensor data. Sensor data may include physiological data, activity data, environmental data, and the like. For example, a galvanic skin response (GSR) sensor may be used to capture or detect a galvanic skin response (GSR) of user 120. A heart rate monitor may be used to capture a heart rate. A thermometer may be used to capture a temperature. An accelerometer may be used to detect acceleration or other motion data. A Global Positioning System (GPS) receiver may be used to capture a location of user 120.

Elements 121-124, 131, and 141 may be in data communication with each other, directly or indirectly, using wired or wireless communications. In some examples, media content response manager 110 may be implemented on media device 131. Wearable devices 121-124 may communicate with media device 131, including transmitting sensor data to media content response manager 110 for analysis. Display 141 may also communicate with media device 131, and data signals associated with media content or other information presented at display 141 may be communicated. Media content response manager 110 may determine a response associated with the media content based on the sensor data received from wearable devices 121-124. In other examples, media content response manager 110 may be implemented on a server (not shown), or another device. Media device 131, which may be integrated with or separate from display 141, may be in data communication with the server. Still, other implementations may be possible.

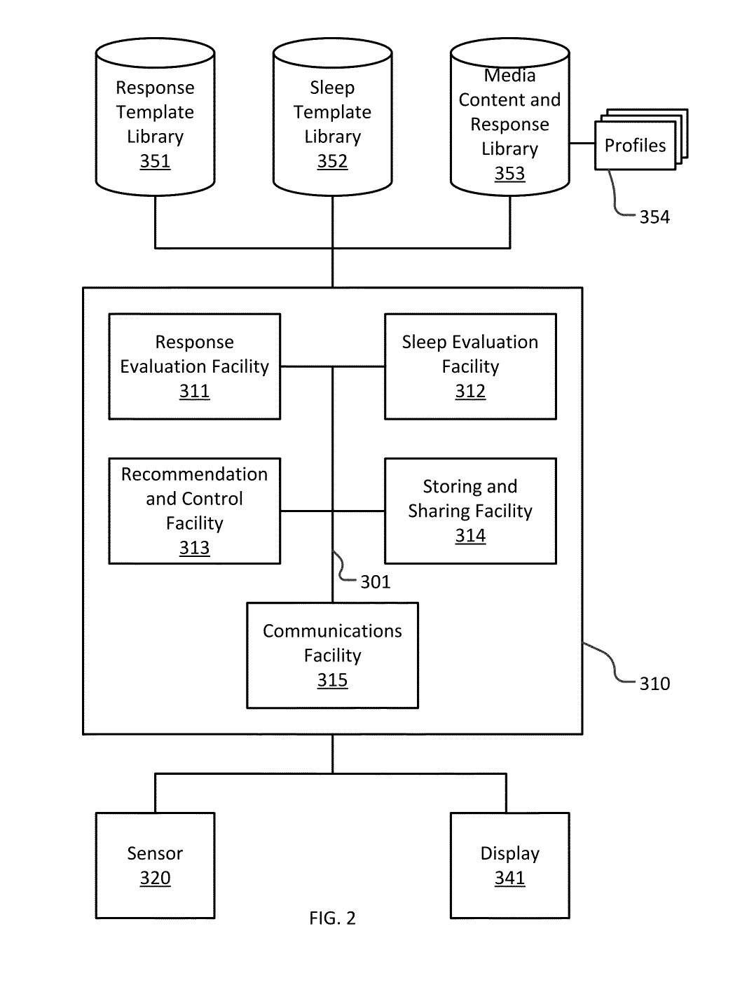

FIG. 2 illustrates an application architecture for a media content response manager, according to some examples. As shown, a media content response manager 310 includes bus 301, a response evaluation facility 311, a sleep evaluation facility 312, a recommendation and control facility 313, a storing and sharing facility 314, and a communications facility 315. Media content response manager 310 is coupled to a sensor 320, a display 341, a response template library 351, a sleep template library 352, and a media content and response library 353, which may include user profiles 354. Communications facility 315 may include a wireless radio, control circuit or logic, antenna, transceiver, receiver, transmitter, resistors, diodes, transistors, or other elements that are used to transmit and receive data, including broadcast data packets, from other devices. In some examples, communications facility 315 may be implemented to provide a “wired” data communication capability such as an analog or digital attachment, plug, jack, or the like to allow for data to be transferred. In other examples, communications facility 315 may be implemented to provide a wireless data communication capability to transmit digitally encoded data across one or more frequencies using various types of data communication protocols, such as Bluetooth, Wi-Fi, 3G, 4G, without limitation. As used herein, “facility” refers to any, some, or all of the features and structures that are used to implement a given set of functions, according to some embodiments.

In some examples, media content response manager 310 may receive data associated with media content that may be configured to be presented at a user interface such as display 341. The data associated with the media content may be received using communications facility 315, may be read from a storage device such as a DVD, or the like. The data associated with the media content may include an identifier of the media content, such as a name, code, unique number, and the like. The data associated with the media content may also include the media content itself, including data to be converted into or output as a display signal to be presented or rendered at a user interface such as display 341. Media content response manager 310 may transmit this data to display 341 to be presented.

In some examples, media content response manager 310 may receive sensor data from sensor 320. Sensor 320 may be various types of sensors and may be one or more sensors. Sensor 320 may be local or external to a wearable device, and may or may not be in data communication with a wearable device. Sensor 320 may be configured to detect or capture an input to be used by media content response manager 310. For example, sensor 320 may detect an acceleration (and/or direction, velocity, etc.) of a motion over a period of time. For example, sensor 320 may include an accelerometer. An accelerometer may be used to capture data associated with motion detection along 1, 2, or 3-axes of measurement, without limitation to any specific type of specification of sensor. An accelerometer may also be implemented to measure various types of user motion and may be configured based on the type of sensor, firmware, software, hardware, or circuitry used. For example, sensor 320 may include a gyroscope, an inertial sensor, or other motion sensors. As another example, sensor 320 may include a galvanic skin response (GSR) sensor, a bioimpedance sensor, an altimeter/barometer, light/infrared (“IR”) sensor, pulse/heart rate (“HR”) monitor, audio sensor (e.g., microphone, transducer, or others), pedometer, velocimeter, GPS receiver or other location sensor, thermometer, environmental sensor, or others. A GSR sensor may be used to detect a galvanic skin response, an electrodermal response, a skin conductance response, and the like. A bioimpedance sensor may be used to detect a bioimpedance, or an opposition or resistance to the flow of electric current through the tissue of a living organism. GSR and/or bioimpedance may be used to determine an emotional or physiological state of an organism. For example, the higher the level of arousal (e.g., physiological, psychological, emotional, etc.), the higher the skin conductance, or GSR. An altimeter/barometer may be used to measure environmental pressure, atmospheric or otherwise, and is not limited to any specification or type of pressure-reading device. An IR sensor may be used to measure light or photonic conditions. A heart rate monitor may be used to measure or detect a heart rate. An audio sensor may be used to record or capture sound. A pedometer may be used to measure various types of data associated with pedestrian-oriented activities such as running or walking. A velocimeter may be used to measure velocity (e.g., speed and directional vectors) without limitation to any particular activity. A GPS receiver may be used to obtain coordinates of a geographic location using, for example, various types of signals transmitted by civilian and/or military satellite constellations in low, medium, or high earth orbit (e.g., “LEO,” “MEO,” or “GEO”). In some examples, differential GPS algorithms may also be implemented with a GPS receiver, which may be used to generate more precise or accurate coordinates. In other examples, a location sensor may be used to determine a location within a cellular or micro-cellular network, which may or may not use GPS or other satellite constellations. A thermometer may be used to measure user or ambient temperature. An environmental sensor may be used to measure environmental conditions, including ambient light, sound, temperature, etc. Still, other types and combinations of sensors may be used. Sensor data captured by sensor 320 may be used by media content response manager 310 to determine a response to media content, a sleep quality or duration after presentation of media content, a parental control or other control of media content, and the like, as described herein.

In some examples, response evaluation facility 311 may determine a response to media content or a portion of media content using sensor data received from sensor 320. Response evaluation facility 311 may access response template library 351 to retrieve one or more response templates or templates. A response template may include one or more types of sensor data and may indicate, correspond to, or be associated with a response and/or a level of a response. A response template may include one or more conditions or criteria associated with sensor data indicating a response. A response template may indicate a response associated with the user's interest in the media content, the user's emotions or activities while watching the media content, and the like (e.g., happy, restful, sad, anxious, walking away from the display, chatting with another person, knitting, doing exercise, sleeping, etc.), and/or a level of the response (e.g., high/low level of happiness, high/low amount of chatting, etc.). For example, a response template may include GSR data. A level of GSR above a threshold level may indicate a high level of arousal, such as fear, surprise, or the like. A level of GSR below the threshold level may indicate a moderate or low level of arousal. As another example, a response template may include conditions or criteria associated with GSR data and audio data. A response template associated with laughing may specify a range for the GSR data, and may include one or more features in audio data that are indicative of or correlate with laughing. As another example, a response template may include conditions associated with motion data and location data. A response template associated with being disinterested in the media content may include motion data associated with walking and location data indicating the user is not nearby display 341. Response evaluation facility 311 may compare sensor data with one or more response templates to determine a match. A match may be a substantial similarity between the sensor data and a response template, or a similarity within a tolerance. A match may be determined based on statistical correlation, machine learning, comparison of one or more features, and the like. A response may be determined in real-time (or substantially real-time), for example, during presentation of media content at display 341. For example, a response may be sampled or determined at a regular frequency, such as every 30 seconds, during the presentation of the media content. A response may be correlated with each time stamp of the media content. Various features of the responses sampled over a time period may be used to perform further analyses, such as for determining a ranking of the media content, determining whether to generate a recommendation, and the like.

In some examples, sleep evaluation facility 312 may determine a sleep quality (e.g., sleep duration, amount of deep sleep, ratio of deep sleep to light sleep, etc.) using sensor data received from sensor 320. Sleep evaluation facility 312 may determine a sleep quality that is affected by or correlated with a portion of media content using sensor data received from sensor 320 after presenting the media content at display 341. Sleep evaluation facility 312 may access sleep template library 351 to retrieve one or more sleep templates. A sleep template may include on or more types of sensor data and may indicate, correspond to, or be associated with a sleep state. A sleep template may include one or more conditions or criteria associated with sensor data indicating a sleep state. For example, a sleep template may include GSR data. A low level of GSR may indicate a person is asleep. As another example, a sleep template may include GSR data and motion data. A sleep template associated with deep sleep may include low GSR and low motion, while a sleep template associated with light sleep may indicate low GSR and moderate motion. Sleep evaluation facility 311 may compare sensor data with one or more sleep templates to determine a match. A match may be a substantial similarity between the sensor data and a response template, or a similarity within a tolerance. A match may be determined based on statistical correlation, machine learning, comparison of one or more features, and the like. Sleep evaluation facility 311 may further determine a duration of a sleep state, a ratio of deep sleep to light sleep, and the like. Sleep evaluation facility 311 may further determine sleep quality. For example, a duration of sleep above 7 hours may be “good,” a duration between 6 and 7 hours may be “moderate,” and a duration below 6 hours may be “poor.” As another example, a ratio of deep sleep to light sleep being 1:1 or higher may be “good,” while a lower ratio may be “poor.”

In some examples, storing and sharing facility 314 may store data representing a response associated with media content at media content and response library 353. Storing and sharing facility 314 may store the data in one or more user profiles 354. A user profile may include an identifier or name of a user, one or more wearable devices associated with the user, biological information of the user (e.g., sex, age, etc.), and other information. A user profile may include a schedule of the user. For example, a user may enter via a user interface that his bedtime is 12 midnight. As another example, a bedtime may be automatically determined based on a wake-up time set by the user. For example, the user enters that the wake-up time for the next day is 7 a.m., and 8 hours of sleep may be desired, thus the bedtime may be 11 p.m. As another example, a calendar of the user may be stored in a memory. For example, the calendar indicates that the user has a meeting at 9 a.m. the next day. A bedtime may be determined based on the calendar. A user profile may include historic data associated with the user, such as information about the user over the past days, months, years, or the like. For example, historic bedtimes of the user may be stored. As another example, historic responses to one or more media content may be stored. Historic responses may be used by recommendation and control facility 313 to provide recommendations for the user. As another example, historic sleep data may be stored, and historic sleep data may be associated with historic response data. For example, a user may have had a past response of being moderately aroused by a portion of media content, and her sleep quality following the presentation of the portion of media content was poor. An association or correlation between moderate arousal and poor sleep quality may be stored. Storing and sharing facility 314 may also share data representing a response associated with a portion of media content using media content and response library 353. Media content and response library 353 may be implemented using a server or a memory that is accessible by a plurality of users. A user may choose to share her response to media content with a friend. A user may share her response to media content using a social network service (e.g., Facebook, Twitter, and the like). A user may share her response anonymously. Media content and response library 353 may store a user's response in a user profile 354 and/or as part of a database or memory of aggregated responses of a plurality of users. Aggregated or historic responses of a plurality of users may be used to provide a response associated with a portion of media content. Aggregated responses may be used to provide a ranking of media content. For example, a portion of media content associated with a higher level of arousal may be higher ranked than another portion of media content associated with a lower level of arousal. The ranking, or other information associated with the responses, may be presented at display 341, a user interface used by a content provider, or other devices. Aggregated responses may also be used by content providers to determine the popularity or effectiveness of media content. Aggregated responses associated with media content may also be used by media content response manager 310 to determine whether the media content is recommended for a user. Media content and response library 353 may store samples of responses throughout a presentation of media content (e.g., associating responses to each time stamp of the media content), and/or may store features of the sampled responses (e.g., high and low peak levels of responses, ratios associated with responses, durations associated with responses, etc.)

Response template library 351, sleep template library 352, and media content and response library 353 may be stored or implemented on a memory or data storage that is integrated with media content response manager 310, or an external memory or server that is in data communication with media content response manager 310 through communications facility 315, using wired or wireless communication. For example, libraries 351-353 may be implemented using various types of data storage technologies and standards, including, without limitation, read-only memory (“ROM”), random access memory (“RAM”), dynamic random access memory (“DRAM”), static random access memory (“SRAM”), static/dynamic random access memory (“SDRAM”), magnetic random access memory (“MRAM”), solid state, two and three-dimensional memories, Flash®, and others. Libraries 351-353 may also be implemented on a memory having one or more partitions that are configured for multiple types of data storage technologies to allow for non-modifiable (i.e., by a user) software to be installed (e.g., firmware installed on ROM) while also providing for storage of captured data and applications using, for example, RAM. Libraries 351-353 may be implemented in the same memory or separate memories. Libraries 351-353 may be implemented on a memory such as a server that may be accessible to a plurality of users, such that one or more users may share, access, create, modify, or use response templates, sleep templates, and responses associated with media content. Once captured and/or stored in libraries 351-353, data may be subjected to various operations performed by other elements of media content response manager 310, as described herein.

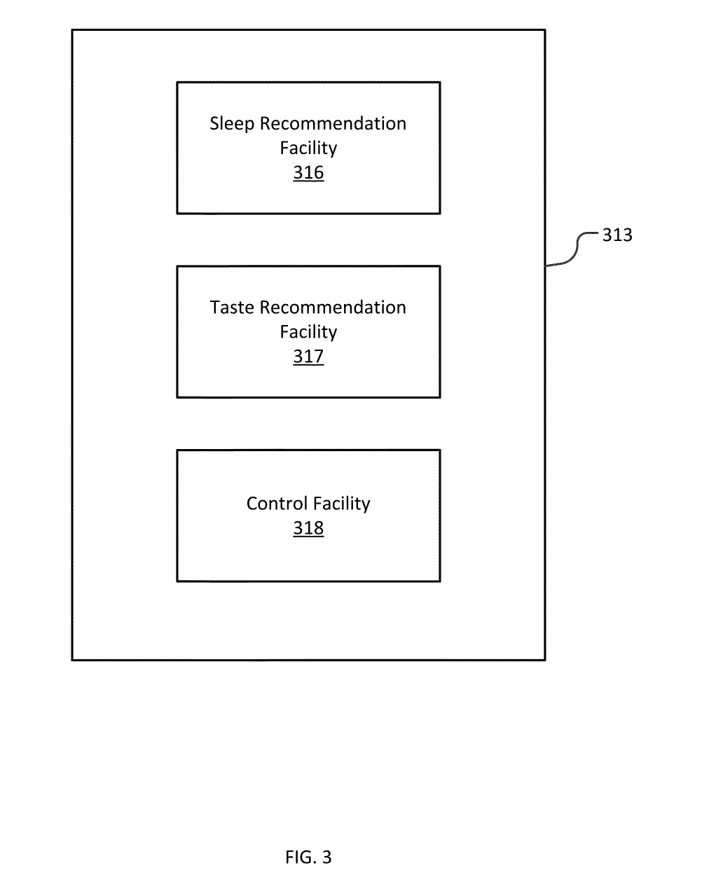

In some examples, recommendation and control facility 313 may generate recommendations and/or controls associated with media content, which may be presented at display 341. For example, recommendation and control facility 313 may recommend that a user watch a certain media content based on the user's past preferences, which may be stored in a user profile. As another example, recommendation and control facility 313 may recommend that a user not watch a portion of media content within one hour before his bedtime based on the user profile and responses of other users associated with the media content. As another example, recommendation and control facility 313 may recommend that a user not watch a portion of media content, or may prevent or stop presentation of the media content, based on a response of the user to the media content. Other functionalities may be provided by recommendation and control facility 313, as described herein (e.g., see FIG. 3). Display 341 may be integrated with media content response manager 310, or may be separate from media content manager 310. Display 341 may be in wired or wireless communication with media content response manager 310. Still other implementations of media content response manager 310 may be used.

FIG. 3 illustrates an application architecture for a recommendation and control facility to be used with a media content response manager, according to some examples. As shown, recommendation and control facility 313 includes a sleep recommendation facility 316, a taste recommendation facility 317, and a control facility 318. Sleep recommendation facility 316 may generate a recommendation associated with a user's sleep quality. Sleep recommendation facility 316 may generate a recommendation using a user's historic data (e.g., stored in a user profile), other users' historic response to a media content (e.g., aggregated and stored in a media content and response library), and/or a user's real-time response to a media content. In some examples, a media content response manager may receive a first set of sensor data from one or more sensors (e.g., sensor 320 in FIG. 2) while a media content is being presented at a display (e.g., display 341 in FIG. 2), and a second set of sensor data after the media content is presented. A response to the media content and a sleep quality may be determined based on the first and second sets of sensor data, as described herein. The response and sleep quality may be stored in a user profile. The user profile may indicate a correlation between a response and a sleep quality, for example, a level of arousal above a threshold causes or correlates with a sleep duration below 5 hours.

In some examples, sleep recommendation facility 316 may receive data associated with another portion of media content, including a response associated with the other portion of media content, such as a plurality of responses of other users, an aggregated response of other users, and the like. Sleep recommendation facility 316 may compare the response associated with poor sleep stored in the user's profile with the response associated with the other portion of media content. For example, the response associated with poor sleep stored in the user's profile may include a level of arousal above a threshold. The response associated with the other portion of media content may include a plurality of responses of other users, which may indicate that 80% of other users have a level of arousal above the threshold. Sleep recommendation facility 316 may determine a match between the response associated with poor sleep stored in the user's profile and the response associated with the other portion of media content. For example, a match may be found if the percentage of other users having a level of arousal above the threshold exceeds a predetermined number, e.g., 50%. Still, other methods of determining a match may be used, such as statistical correlation, comparison of one or more features, machine learning, and the like. Based on the match, sleep recommendation facility 316 may generate a recommendation to the user to not watch the media content. Sleep recommendation facility 316 may further generate a recommendation as a function of the current time, such as, whether the current time is within a timeframe before the user's bedtime. The user's bedtime may be manually entered or determined using the user's wake-up time or schedule, or the like. For example, the current time may be within one hour before the user's bedtime, and sleep recommendation facility 316 may generate a recommendation to not present the media content to the user.

In some examples, sleep recommendation facility 316 may receive the user's real-time response to a portion of media content. In one example, the real-time response may match a response associated with poor sleep stored in a user profile. In another example, the real-time response may match a response associated with poor sleep of other users. For example, a high level of fear may be associated with a sleep duration below 5 hours. Sleep recommendation facility 316 may process the user's response to the media content in real time. For example, at the beginning of the presentation of the media content, the user's response may include low arousal, such as being moderately happy, restful, relaxed, or the like. As the media content continues to be presented, the response changes, for example, to include a high level of fear. When the high level of fear is captured, or after a high level of fear is detected for a sustained period of time, sleep recommendation facility 316 may determine a match with the response associated with poor sleep, and may generate a recommendation to stop watching the media content. Still, other methods for determining a match may be used. The recommendation may be presented to the user in real time, for example, during presentation of the media content. The recommendation may be presented as an overlay over the presentation of the media content, as a sidebar, or in another fashion.

Taste recommendation facility 317 may generate a recommendation associated with a user's programming tastes or preferences. In some examples, a user profile may store a plurality of responses to a plurality of portions of media content, which may have been presented to the user in the past. The frequency of a type of response may indicate a user's preference for media content that induce that type of response. For example, a user profile may have a plurality of historic responses, wherein 70% of them include a high level of happiness, and 30% include a high level of sadness. This user profile may indicate that the user enjoys or prefers media content that induce happiness (e.g., comedies, happy endings, etc.). In some examples, taste recommendation facility 317 may receive data associated with a portion of media content, including a response associated with the portion of media content, which may be based on responses of other users to the portion of media content. The data associated with the portion of media content may be retrieved as a result of a search of an index of media content, may be received from a provider or advertiser promoting the media content, or by other means. The response of associated with the portion of media content may be compiled based on historic responses to the portion of media content of other users. Taste recommendation facility 317 may compare the response preferred by the user (e.g., the response having a high frequency in the user's historic data) to the response associated with the portion of media content to determine a match. For example, the preferred response may be a high level of happiness, and taste recommendation facility 317 may determine whether the response associated with the portion of media content includes a high level of happiness. Taste recommendation facility 317 may cause presentation of a recommendation suggesting the portion of media content associated with a high level of happiness to the user.

Control facility 318 may generate controls, locks, or bans on media content, or may generate recommendations to not watch media content. The control or recommendation may be generated based on the user's historic data, the user's real-time response data, and/or historic responses of other users to the media content. In some examples, a user profile may include data associated with a response indicating controlled media content. The response may be manually input. For example, a parent may input a response indicating controlled media content for a user who is a child. For example, a response indicating controlled media content may include being scared. In some examples, control facility 318 may receive data associated with media content that is to be presented to a user, including a response associated with the media content. The media content may be selected by the user to be presented on a display. The media content may be presented as part of a programming schedule preset or predetermined by a content provider. Control facility 318 may compare the response indicating controlled media content stored in a user profile to the response associated with the media content to be presented to determine a match. The response associated with the media content may be based on historic responses to the media content of other users. For example, the response indicating controlled media content may include being scared, and over 50% of historic responses of other users to a portion of media content may include being scared, then control facility 318 may determine a match, and may implement control over the portion of media content, for example, by not presenting the portion of media content to the user. Control facility 318 may allow presentation of other portions of media content while censoring or blocking out the portion of media content associated with being scared. In some examples, a portion of media content may be presented to a user, and a response to the media content may be determined in real time. Other methods of determining a match may be used. In some examples, control facility 318 may compare a response indicating controlled media content stored in a user profile to the user's response to the media content being presented in real time. Control facility 318 may determine a match, and may control presentation of the media content, for example, by not presenting the media content. Still, other implementations of recommendation and control facility 313 may be used.

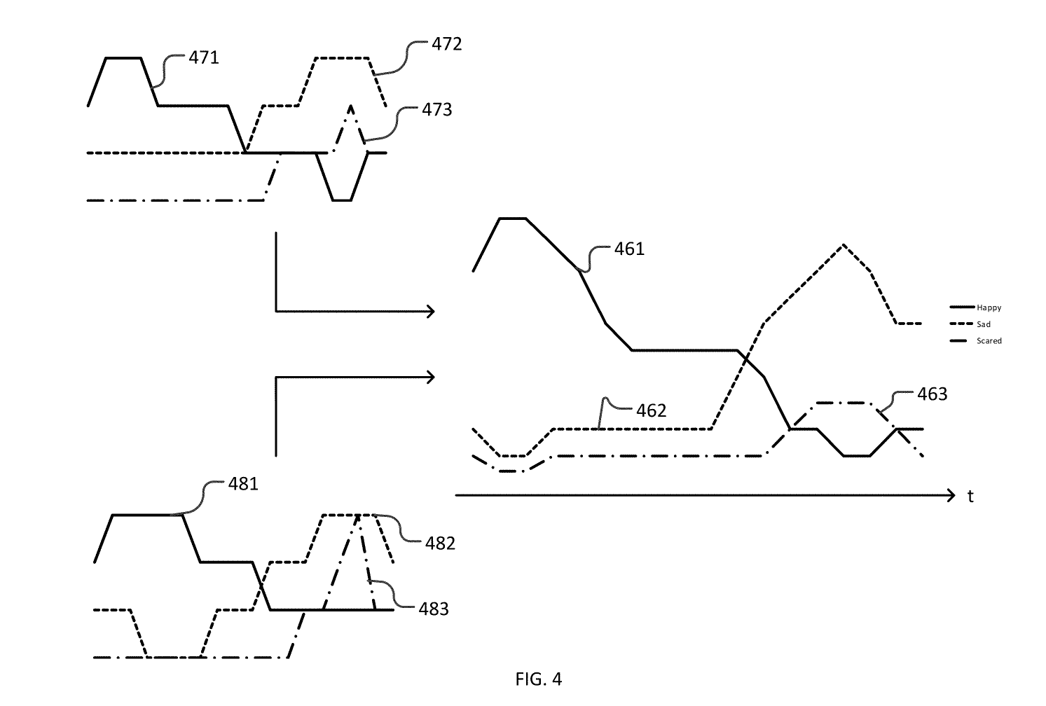

FIG. 4 illustrates responses to a portion of media content over time, determined by a media content response manager, according to some examples. As shown, FIG. 4 includes a representation of a first, second, and third response (e.g., happy, sad, scared) over time associated with a portion of media content of a first user 471-473, 481, a representation of a first, second, and third response (e.g., happy, sad, scared) over time associated with the portion of media content of a second user, and a representation of an aggregated first, second, and third response (e.g., happy, sad, scared) over time associated with the portion of media content of a plurality of users 461-463. In some examples, one or more responses (e.g., responses 471-473 and 481-483) may be determined based on sensor data associated with the first and second users, respectively. As shown, responses 471-473 and 481-483 may be based on a sampling of sensor data during the presentation of media content. The responses 471-473 and 481-483 may or may not be further classified into different levels. For example, as shown, the responses 471-473 and 481-483 have four levels (e.g., levels 0, 1, 2, 3, or none, low, medium, high, etc.). The first user's responses 471-473 may be different from the second user's responses 481-483 to the same media content. The first user's responses 471-473 may be stored in a profile of the first user, and the second user's responses 481-483 may be stored in a profile of the second user. The responses 471-473 and 481-483 may be shared with other users, using a server or other memory accessible by other users. Aggregated responses 461-463 may be determined based on responses of individual users (e.g., responses 471-473 and 481-483). In some examples, aggregated responses 461-463 may be determined as a function of summing individual responses. For example, response 461, which may indicate happiness, may be a function of the sum of responses 471 and 481, which may also indicate happiness. For example, at a certain time in the presentation of a portion of media content, response 471 may be at level 2 (or medium level), and response 481 may be at level 3 (or high level). An aggregated response may be the sum of 2 and 3 (e.g., 5). Aggregated responses 461-463 may be determined as a function of an average or normalization of individual responses. Averaging may involve dividing the sum of individual responses by the product of the number of individual responses and the maximum level of the responses. For example, at a certain time, response 471 may be at level 2 (or medium level), and response 481 may be at level 3 (or high level). The maximum level of the responses may be level 3. An aggregated response may be the sum of 2 and 3, divided by the product of 3 and 2 (e.g., 5/6=0.83). In some examples, a percentage of the individual responses 471-473 and 481-483 having a certain feature may be used to determine an aggregated response. Still, other methods for determining aggregated responses may be used.

Aggregated responses 461-463 may be used by a media content response manager. For example, a media content response manager may use aggregated responses 461-463, which may be associated with a portion of media content, to determine whether to recommend the portion of media content to a user. For example, a media content response manager may compare aggregated responses 461-463 (or a subset thereof) to historic responses, which may indicate a user's taste, stored in a user profile. A media content response manager may determine a match and recommend the portion of media content to the user. In some examples, a match may be determined based on statistical correlation, machine learning (e.g., clustering, reinforcement learning, supported vector machine), neural networks, comparing features of the responses (e.g., the number or level of peaks in a response, the amount or percentage of time during which a type of response is provided, the smoothness of a response over time, etc.), and the like. For example, aggregated responses 461-463 may indicate that a level of happiness of 2 or more accounts for 70% of the time during which the portion of media content is being presented. An average percentage of time associated with a level of happiness of 2 or more in a user's historic responses may be 65%. A match may be found if the percentage of time associated with a level of happiness of 2 or more in the response associated with the portion of media content is within a range, such as 8%, of that associated with the user's historic responses. Hence, a match may be found. Still, other implementations may be used.

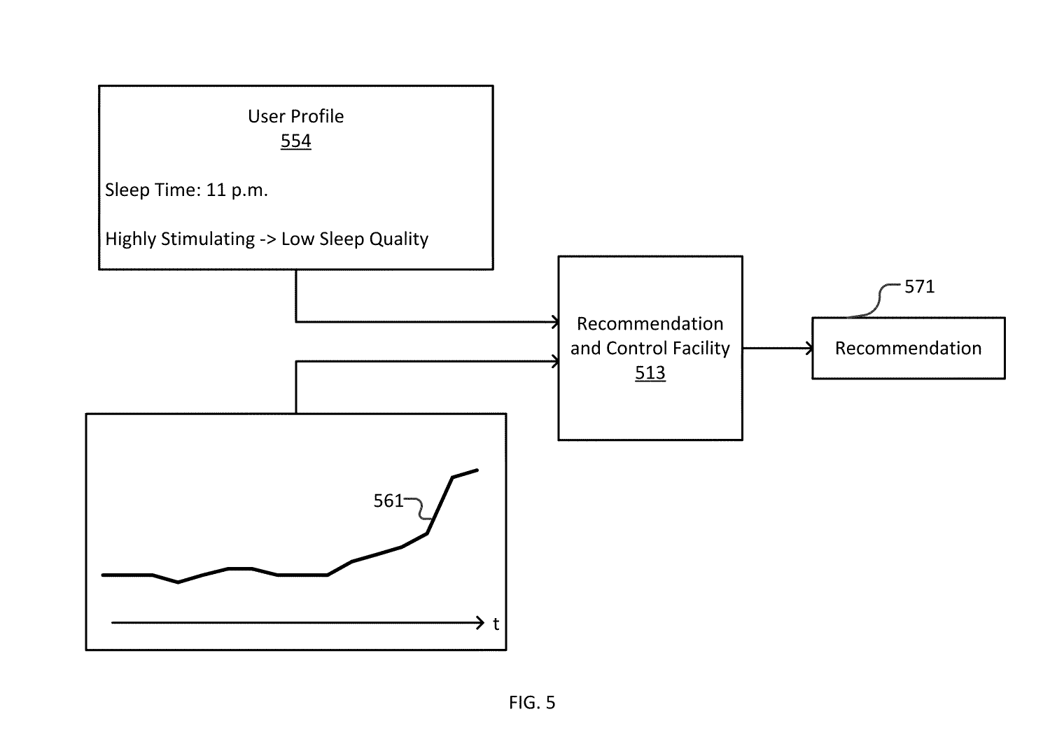

FIG. 5 illustrates a recommendation generated by a recommendation and control facility to be used with a media content response manager, according to some examples. As shown, FIG. 5 includes a user profile 554, a user's response to a portion of media content captured in real time (or substantially real time) 561, recommendation and control facility 513, and recommendation 571. User profile 554 may include data indicating that a user's sleep time (e.g., sleep time), and a response associated with poor sleep quality (e.g., highly stimulated or aroused). A user's sleep time may be manually entered by a user, or may be determined based on a user's habits or historic data, a user's schedule, a wake-up time, or the like. The response associated with poor sleep quality may be manually entered by a user, or may be determined based on a user's historic data, the historic data of other users (e.g., the user's friends or family), and the like. Response 561 may be determined based on one or more types of sensor data, such as GSR, motion, audio, temperature, location, and the like. For example, as shown, response 561 may indicate a low level of stimulation or arousal at the beginning of the presentation of the portion of media content. After a period of time, response 561 may indicate a high level of arousal, or a level of arousal that exceeds a threshold. Recommendation and control facility 513 may compare response 561 to the response associated with poor sleep quality stored in user profile 554. When response 561 indicates a high level of arousal, recommendation and control facility 513 may determine a match. Recommendation and control facility 513 may further determine that the current time is within a timeframe of the user's sleep time (e.g., within one hour of the user's sleep time). Recommendation and control facility 513 may generate and cause presentation of a recommendation suggesting the user to not watch the portion of media content. The recommendation may be presented to the user on the same or a different display or user interface that is being used to present the portion of media content. The recommendation may be presented in real time or substantially real time, or while the portion of media content is being presented. Recommendation and control facility 513 may further pause or stop presentation of the portion of media content. Still, other implementations may be used.

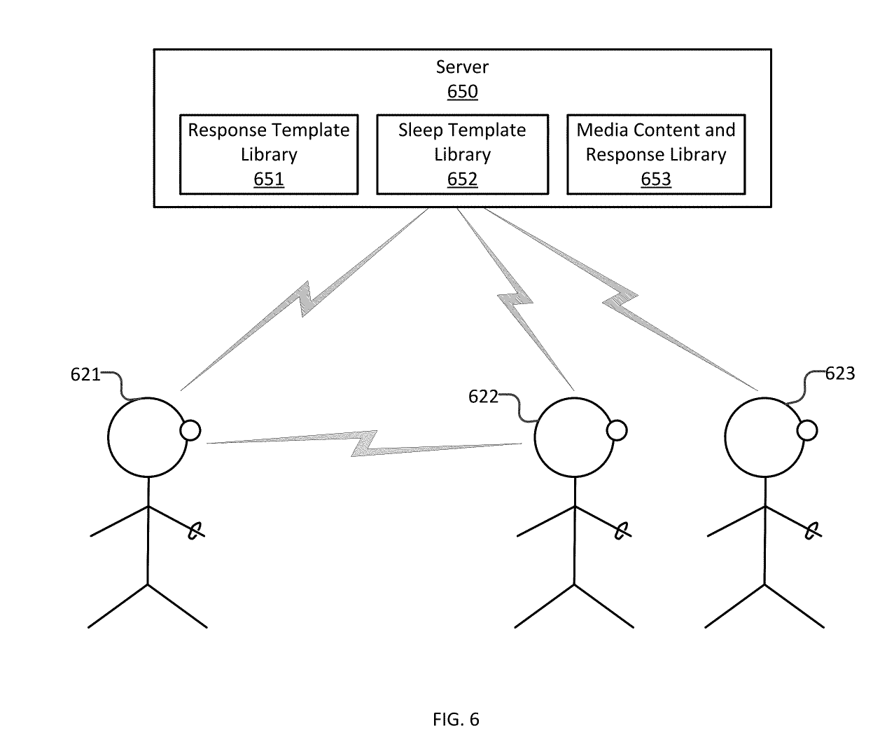

FIG. 6 illustrates a network of wearable devices of a plurality of users, the wearable devices to be used with one or more media content response managers, according to some examples. As shown, FIG. 6 includes server or node 650, response template library 651, sleep template library 652, media content and response library 653, and users 621-623. Each user 621-623 may use one or more wearable devices having one or more sensors. The sensors may be used to capture sensor data to be used by one or more media content response managers. The devices of users 621-623 may communicate with each other over a network, and may be in direct data communication with each other, or be in data communication with server 650. Server 650 may include response template library 651, sleep template library 652, media content and response library 653. Response template library 651 may include one or more templates specifying or having sensor data that indicates a response. For example, a high level of GSR may indicate a high level of arousal. As another example, a high level of GSR and an audio signal having a high frequency and amplitude may indicate a high level of fear. Sleep template library 652 may include one or more templates specifying or having sensor data that indicates a sleep state. For example, a low level of GSR and a low level of motion may indicate deep sleep. Media content and response library 653 may include one or more responses associated with media content. For example, media content and response library 653 may add a tag to a portion of media content, the tag including data representing a response. As another example, media content and response library 653 may include a table storing different types of responses and the corresponding identifiers of portions of media content. Users 621-623 may upload, share, or store data on library 651-653, and may retrieve or download data from libraries 651-653. For example, user 621 may upload his sensor data associated with a portion of media content, and he may manually enter data indicating that this sensor data is associated with excitement. This sensor data may be stored as a response template indicating excitement at response template library 651, or this sensor data may be used to modify an existing response template indicating excitement. This template may be downloaded by user 621 or other users 622-623. This template may be compared with other sensor to determine whether there is a match. For example, user 621 may upload her sensor data associated with sleep, and this sensor data may be stored as a sleep template at sleep template library 652. This template may be downloaded by user 621 or other users 622-623. For example, a response to a portion of media content of user 621 may be stored at media content and response library 653. The response may be shared with other users 622-623. The response may be transmitted to users 622-623 directly or indirectly (e.g., using server 650). The response may be used to form an aggregated response associated with the portion of media content. The response or the aggregated response may be downloaded or retrieved by the user or other users, which may be used to determine whether a recommendation should be made. Still, other implementations may be used.

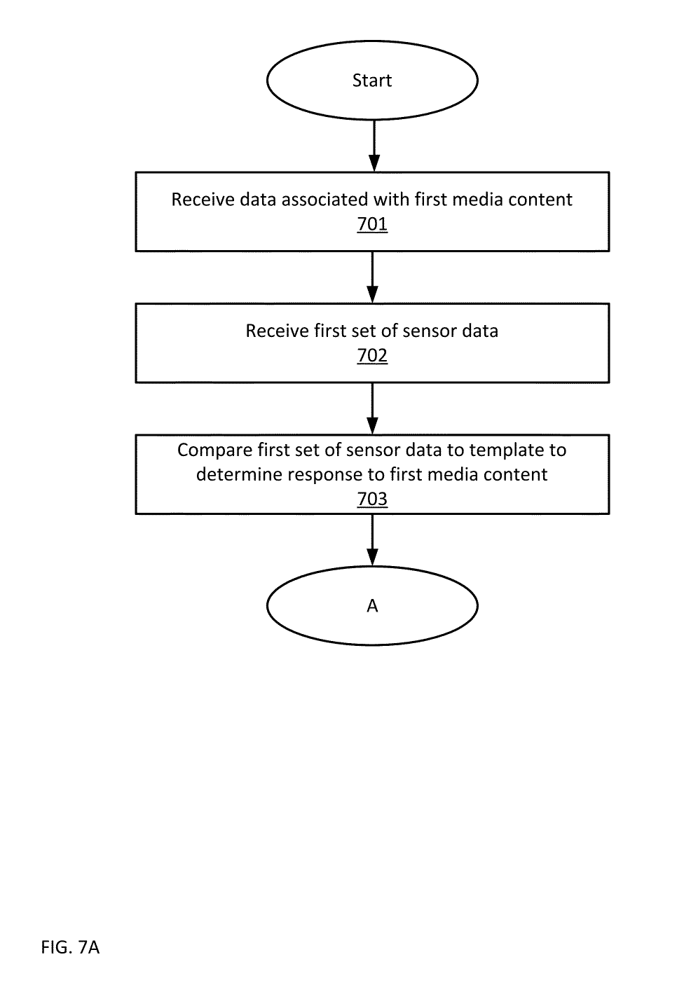

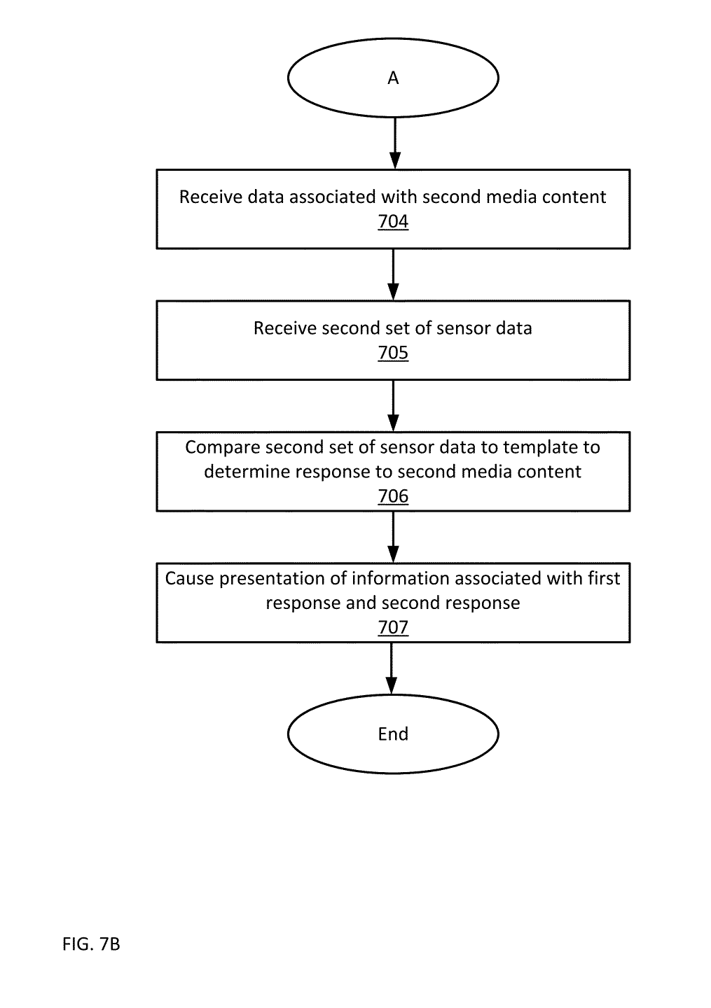

FIGS. 7A and 7B illustrate a process for a media content response manager, according to some examples. In FIG. 7A, at 701, data associated with a first portion of media content may be received. The first portion of media content may be configured to be presented at a user interface, such as a display or the like. The first portion of media content may be a television program, a movie, an advertisement, a soundtrack, and the like. At 702, a first set of sensor data may be received from one or more sensors coupled to a wearable device. The first set of sensor data may include a first galvanic skin response data. The sensor data may be received while the first portion of media content is being presented. At 703, the first set of sensor data may be compared to one or more templates to determine a first response to the first portion of media content. A template may include one or more conditions or criteria associated with sensor data indicating a response. For example, a template may specify a condition that GSR data must be within a certain range, and the template may be associated with the response of being moderately happy. The sensor data may be compared to the template, for example, to determine whether the GSR data is within the range. A match may be found if there is a substantial similarity, or a similarity within a tolerance. In FIG. 7B, at 704, data associated with a second portion of media content may be received. The second portion of media content may be configured to be presented at the user interface. At 705, a second set of sensor data may be received from the one or more sensors coupled to the wearable device. The second set of sensor data may include a second galvanic skin response data. At 706, the second set of sensor data may be compared to the one or more templates to determine a second response to the second portion of media content. At 707, presentation of information associated with the first response and the second response may be caused at the user interface. For example, a ranking of the first portion of media content and the second portion of media content based on the first response and the second response may be presented. As another example, the first response and the second response may be presented. Still, other implementations and processes may be possible.

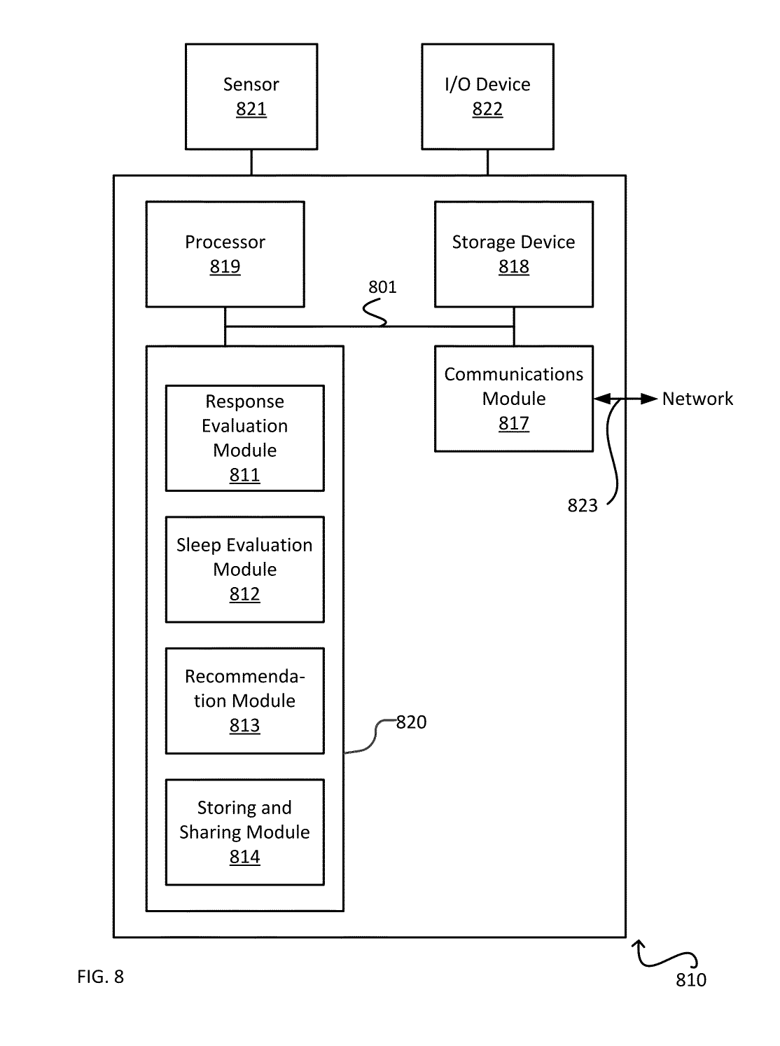

FIG. 8 illustrates a computer system suitable for use with a media content response manager, according to some examples. In some examples, computing platform 810 may be used to implement computer programs, applications, methods, processes, algorithms, or other software to perform the above-described techniques. Computing platform 810 includes a bus 801 or other communication mechanism for communicating information, which interconnects subsystems and devices, such as processor 819, system memory 820 (e.g., RAM, etc.), storage device 818 (e.g., ROM, etc.), a communications module 817 (e.g., an Ethernet or wireless controller, a Bluetooth controller, etc.) to facilitate communications via a port on communication link 823 to communicate, for example, with a computing device, including mobile computing and/or communication devices with processors. Processor 819 can be implemented with one or more central processing units (“CPUs”), such as those manufactured by Intel® Corporation, or one or more virtual processors, as well as any combination of CPUs and virtual processors. Computing platform 810 exchanges data representing inputs and outputs via input-and-output devices 822, including, but not limited to, keyboards, mice, audio inputs (e.g., speech-to-text devices), user interfaces, displays, monitors, cursors, touch-sensitive displays, LCD or LED displays, and other I/O-related devices. An interface is not limited to a touch-sensitive screen and can be any graphic user interface, any auditory interface, any haptic interface, any combination thereof, and the like. Computing platform 810 may also receive sensor data from sensor 821, including a heart rate sensor, a respiration sensor, an accelerometer, a GSR sensor, a bioimpedance sensor, a GPS receiver, and the like.

According to some examples, computing platform 810 performs specific operations by processor 819 executing one or more sequences of one or more instructions stored in system memory 820, and computing platform 810 can be implemented in a client-server arrangement, peer-to-peer arrangement, or as any mobile computing device, including smart phones and the like. Such instructions or data may be read into system memory 820 from another computer readable medium, such as storage device 818. In some examples, hard-wired circuitry may be used in place of or in combination with software instructions for implementation. Instructions may be embedded in software or firmware. The term “computer readable medium” refers to any tangible medium that participates in providing instructions to processor 819 for execution. Such a medium may take many forms, including but not limited to, non-volatile media and volatile media. Non-volatile media includes, for example, optical or magnetic disks and the like. Volatile media includes dynamic memory, such as system memory 820.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 801 for transmitting a computer data signal.

In some examples, execution of the sequences of instructions may be performed by computing platform 810. According to some examples, computing platform 810 can be coupled by communication link 823 (e.g., a wired network, such as LAN, PSTN, or any wireless network) to any other processor to perform the sequence of instructions in coordination with (or asynchronous to) one another. Computing platform 810 may transmit and receive messages, data, and instructions, including program code (e.g., application code) through communication link 823 and communication interface 817. Received program code may be executed by processor 819 as it is received, and/or stored in memory 820 or other non-volatile storage for later execution.

In the example shown, system memory 820 can include various modules that include executable instructions to implement functionalities described herein. In the example shown, system memory 820 includes response evaluation module 811, sleep evaluation module 812, recommendation module 813, and storing and sharing module 814. A response template library, a sleep response library, and a media content and response library may be stored on storage device 818 or another memory.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A method, comprising:
receiving data associated with a first portion of media content, the first portion of media content being configured to be presented at a display;
receiving a first set of sensor data from one or more sensors coupled to a wearable device, the first set of sensor data including a first galvanic skin response data;
comparing the first set of sensor data to one or more templates to determine a first response to the first portion of media content; and
causing presentation of information associated with the first response at the display.

2. The method of claim 1, further comprising:
receiving a second set of sensor data from the one or more sensors coupled to the wearable device, after the receiving data associated with the first portion of media content;
determining a duration of sleep is below a threshold using the second set of sensor data; and
causing presentation of a recommendation associated with the duration of sleep at the display.

3. The method of claim 1, further comprising:
receiving data representing a user profile, the user profile having data associated with a response associated with a duration of sleep being below a threshold;
comparing the first response to the response associated with the duration of sleep being below the threshold to determine a match; and
causing presentation of a recommendation as a function of the match at the display.

4. The method of claim 3, further comprising:
receiving data representing a current time,
wherein the recommendation is further a function of the current time.

5. The method of claim 1, further comprising:
receiving data associated with a second portion of media content, the second portion of media content being associated with a second response;
comparing the first response and the second response to determine a match; and
causing presentation of a recommendation associated with the second portion of media content at the display.

6. The method of claim 5, wherein the second response comprises an aggregation of a plurality of historic responses to the second portion of media content of a plurality of users.

7. The method of claim 1, further comprising:
receiving data representing a user profile, the user profile having data associated with a plurality of historic responses to a plurality of portions of media contents;
comparing the first response to the plurality of historic responses to determine a match; and
causing presentation of a recommendation as a function of the match at the display.

8. The method of claim 7, further comprising:
receiving a plurality of sets of sensor data from the one or more sensors coupled to the wearable device; and
determining the plurality of historic responses using the plurality of sets of sensor data.

9. The method of claim 1, further comprising:
receiving data representing a user profile, the user profile having data associated with a response indicating a portion of controlled media content;
comparing the first response to the response indicating a portion of controlled media content to determine a match; and
causing the first portion of media content to not be presented at the display.

10. The method of claim 1, further comprising:
storing the data representing the first response in a user profile.

11. The method of claim 1, further comprising:
storing the data representing the first response in a memory, the memory being accessible by a plurality of users.

12. The method of claim 1, further comprising:
receiving data associated with a second portion of media content, the second portion of media content being configured to be presented at the display;
receiving a second set of sensor data from the one or more sensors coupled to the wearable device, the second set of sensor data including a second galvanic skin response data;
comparing the second set of sensor data to the one or more templates to determine a second response to the second portion of media content; and
causing presentation of a ranking of the first portion of media content and the second portion of media content based on the first response and the second response at the display.

13. A system, comprising:
a memory configured to store data associated with a first portion of media content, and to store a first set of sensor data received from one or more sensors coupled to a wearable device; and
a processor configured to compare the first set of sensor data to one or more templates to determine a first response to the first portion of media content, and to cause presentation of information associated with the first response at a display,
wherein the first portion of media content is configured to be presented at the display, and the first set of sensor data includes a first galvanic skin response data.

14. The system of claim 13, wherein:
the memory is further configured to store a second set of sensor data from the one or more sensors coupled to the wearable device; and
the processor is further configured to determine a duration of sleep is below a threshold using the second set of sensor data, and to cause presentation of a recommendation associated with the duration of sleep at the display.

15. The system of claim 13, wherein:
the memory is further configured to store data representing a user profile, the user profile having data associated with a response associated with a duration of sleep being below a threshold; and
the processor is further configured to compare the first response to the response associated with the duration of sleep being below the threshold to determine a match, and to cause presentation of a recommendation as a function of the match at the display.

16. The system of claim 13, wherein:
the memory is further configured to store data representing a user profile, the user profile having data associated with a plurality of historic responses to a plurality of portions of media contents; and
the processor is further configured to compare the first response to the plurality of historic responses to determine a match, and to cause presentation of a recommendation as a function of the match at the display.

17. The system of claim 16, wherein:
the processor is further configured to receive a plurality of sets of sensor data from the one or more sensors coupled to the wearable device, and to determine the plurality of historic responses using the plurality of sets of sensor data.

18. The system of claim 13, wherein:
the memory is further configured to receive data representing a user profile, the user profile having data associated with a response indicating a portion of controlled media content; and
the processor is further configured to compare the first response to the response indicating a portion of controlled media content to determine a match, and to cause the first portion of media content to not be presented at the display.

19. The system of claim 13, wherein:
the processor is further configured to store the data representing the first response in another memory, the another memory being accessible by a plurality of users.

20. The system of claim 13, wherein:
the memory is further configured to store data associated with a second portion of media content, and to store a second set of sensor data received from the one or more sensors coupled to the wearable device; and
the processor is further configured to compare the second set of sensor data to the one or more templates to determine a second response to the second portion of media content, and to cause presentation of a ranking of the first portion of media content and the second portion of media content based on the first response and the second response at the display,
wherein the second portion of media content is configured to be presented at the display, and the second set of sensor data includes a second galvanic skin response data.
